(19) United States
(12) Patent Application Publication
(10) Pub. No.: US 2016/0292155 A1
(43) Pub. Date: Oct. 6, 2016

(54) A SYSTEM AND METHOD TO PRE-FETCH COMPARISON MEDICAL STUDIES

(71) Applicant: AGFA HEALTHCARE NV, B-Mortsel (BE)

(72) Inventors: Roel ADRIAENSENS, Mortsel (BE); Joost FELIX, Mortsel (BE); Wannes KIECKENS, Mortsel (BE)

(73) Assignee: AGFA HEALTHCARE, B-Mortsel (BE)

(21) Appl. No.: 15/036,870

(22) PCT Filed: Nov. 26, 2014
(86) PCT No.: PCT/EP2014/075674

§ 371 Date: May 16, 2016

(30) Foreign Application Priority Data
Nov. 28, 2013 (EP) 13194896.0

(51) Int. Cl. G06F 17/30; G06F 19/00

(52) U.S. Cl. CPC G06F 17/30011; G06F 19/321; G06F 17/30507

(57) ABSTRACT

A system for pre-fetching in a medical imaging and archiving platform a subset of comparison medical studies in relation to an active medical study includes a medical study database to store medical studies; a relevancy rule database to store relevancy rules that express relevancy of a comparison medical study in view of an active medical study; a relevancy rule manager enabling to define the relevancy rules; and a relevancy rule engine to select for the active medical study applicable relevancy rules from the relevancy rule database, and to apply the selected relevancy rules to pre-fetch the subset of comparison medical studies. The relevancy rules include enhanced relevancy rules using contextual information stored in a medical report, an order, or procedure information that forms part of the medical studies.

### CROSS-REFERENCE TO RELATED APPLICATIONS

This application is a 371 National Stage Application of PCT/EP2014/075674, filed Nov. 26, 2014. This application claims the benefit of European Application No. 13194896.0, filed Nov. 28, 2013, which is incorporated by reference herein in its entirety.

### BACKGROUND OF THE INVENTION

1. Field of the Invention

The present invention generally relates to medical imaging and archiving systems. More particularly, the invention concerns retrieval of prior available medical information that forms part of so called comparison medical studies that are archived and relevant when interpreting or analysing newly acquired medical information that forms part of a so called active medical study. The comparison study can for instance be an earlier study. The present invention aims at disclosing a system and method for pre-fetching comparison medical studies that reduces network traffic, reduces cache memory requirements, and enhances the user experience through a more relevant and faster selection of comparison medical studies.

2. Description of the Related Art

When analysing newly acquired medical information, i.e. an actual medical study, a healthcare professional such as a radiologist or physician, often desires to compare the newly acquired medical information with information from comparison medical studies, for instance earlier studies to determine the progress of a disease, tumour growth, etc. In such temporal diagnosis where earlier available information is compared with newly acquired information, a relevancy rule engine can help the healthcare professional in selecting the relevant comparison medical studies. In existing systems, the relevancy rules used to pre-fetch relevant comparison studies typically rely on imaging information such as modality type and body part to make a selection of the comparison medical studies that will be presented to the healthcare professional analysing the actual medical study. The selection of comparison medical studies based on imaging properties and information however often does not result in the most relevant prior medical studies being selected. As a result, the healthcare professional does not rely on the most appropriate available information to make an analysis, or he/she will have to select the more appropriate available information manually. In the latter case, the automated pre-fetching of comparison medical studies represents superfluous network traffic, waste of time, and waste or inadequate use of cache space.

The medical imaging and archiving system pre-fetches images (and/or summaries of information relating to the images) in response to a scheduled event. In this regard, “pre-fetching” refers to the process of automatically (i.e., without user intervention) retrieving images (and/or summaries) before the scheduled event. In this aspect, the medical imaging and archiving system includes at least one station capable of displaying the images, and a network gateway which communicates with the station and a remote source (e.g., a hospital radiology information system, or “RIS”). The network gateway receives information concerning the scheduled event from the remote source, queries the remote source for details on the scheduled event, receives the details from the remote source, and retrieves images (and/or summaries) from a memory on the PACS based on the details and one or more predetermined pre-fetching rules. By effecting pre-fetching in this manner, the invention further reduces the amount of time required to review images. That is, because the images and/or summaries have been pre-fetched, they will be ready and waiting for the reviewer (e.g., a physician) at the time of the exam. With regard to the summaries, retrieval of the summaries only is a significant advantage, since it eliminates the need to retrieve an image when only its summary is needed.

For healthcare professionals, it is important that that the relevance rules enable the pre-fetching function to successfully select and pre-load the most relevant comparison studies. When the most relevant comparison studies are already available, the healthcare professional will be able to analyse the newly acquired study more quickly. Consequently, the healthcare professionals efficiency and performance will increase.

Network administrators must balance the healthcare professionals desire to have the most relevant comparison studies available with the objective to minimize cache space requirements and network traffic. For network administrators, it is consequently of utmost importance that the relevancy rules are successful in selecting only the most relevant comparison medical studies. This way, use of bandwidth and cache memory for pre-loading comparison studies that are not useful in the diagnosis is reduced or avoided.

Relevancy rules that merely rely on imaging information fail to select the most relevant comparison studies with minimized usage of bandwidth and cache space. For instance a radiologist analysing a new study of an oncology patient considers earlier studies from far different modalities and body parts as relevant. A radiologist analysing a new study of a trauma patient on the contrary finds earlier studies less relevant.

### SUMMARY OF THE INVENTION

It is an objective of the present invention to disclose a method and system for pre-fetching comparison medical studies that overcomes the above defined technical shortcomings of the prior art. More particularly, it is an objective of the present invention to disclose a method and system for pre-fetching comparison medical studies that is more efficient in selecting the most relevant comparison studies while reducing the amount of network traffic and reducing the cache memory requirements.

In accordance with preferred embodiments of the present invention, the above defined objectives are achieved by the system able to pre-fetch in a medical imaging and archiving platform a subset of comparison medical studies in relation to an active medical study as defined below, the system comprising:

a medical study database adapted to store medical studies;
a relevancy rule database adapted to store relevancy rules that express relevancy of an comparison medical study in view of an active medical study;
a relevancy rule manager enabling a user of the system to define the relevancy rules; and
a relevancy rule engine adapted to select for the active medical study applicable relevancy rules from the relevancy rule database, and to apply selected relevancy rules to thereby pre-fetch the subset of comparison medical studies,
wherein the relevancy rules comprise one or more relevancy rule using contextual information stored in a medical report, an order or procedure information that forms part of the medical studies.

Thus, preferred embodiments of the invention make use of enhanced relevancy rules, stored in a relevancy rule database and used by a relevancy rule engine to pre-fetch a subset of comparison studies. The enhanced relevancy rules use contextual information extracted from medical reports, orders and procedure descriptions in addition to imaging information to select for each actual study the most relevant available comparison studies. A system according to the present invention hence tackles the challenge that the medical report, order and procedure information for comparison studies is separated from the images. The medical report however typically describes the diagnosis and consequently contains valuable contextual information that is helpful in determining if a comparison study is relevant or not when analysing a new, actual study. In order to be able to use contextual information, the relevancy rule engine must be equipped with interfaces and search tools that enable to search for medical report content, order content and procedural content in the medical study database that archives the comparison studies. In addition, the relevancy rule manager, i.e. the graphical user interface administrator desktop that enables administrators of the system to define relevancy rules must be enhanced to specify as part of the relevancy rules conditions that involve consulting contextual information such as parameters mentioned in medical reports, orders and/or procedure descriptions. Thanks to the enhanced relevancy rules, the most relevant comparison medical studies will be selected enabling the healthcare professional to save time and perform a better diagnosis. In addition, to the advantage of the network administrator, the overall network traffic resulting from preloading the comparison studies will reduce and cache space requirements are reduced as well.

It is noticed that the relevancy rule database and the medical report database are preferably separated. This brings the additional advantage that the relevancy rule database must not be migrated when a further medical study database is added to the system or when a different medical study database will be used by the system.

According to an optional aspect of the system to pre-fetch comparison medical studies according to the present invention, the contextual information comprises Radiology Information System data or RIS data.

Indeed, whereas existing systems that are able to pre-fetch comparison studies typically rely on relevancy rules that use only PACS or Picture Archiving and Communication System data, the present invention relies on enhanced relevancy rules that preferably use also RIS data, i.e. information extracted from orders, reports or linked information like the severity, procedural information, diagnostic codes, administrative information like the department that requested the study, etc.

According to a further optional aspect of the system to pre-fetch comparison medical studies according to the present invention, the relevancy rule manager is adapted to enable to define the relevancy rules in a translatable domain specific language or dsl, meaning that the domain specific language can be translated into different (spoken) human languages.

The use of dsl provides the administrator that defines the enhanced relevancy rules a user-friendly, easy-to-understand tool wherein rules are expressed in a near-natural language.

Further optionally, in the system to pre-fetch comparison medical studies according to the present invention:

the relevancy rule manager is adapted to enable to define the relevancy rules as if-then rules; and
the relevancy rule engine is adapted to verify fulfilment of the if-condition of the selected relevancy rules in order to select the applicable relevancy rules, and to execute the then-part of the selected relevancy rules to pre-fetch the subset of comparison medical studies.

If-then expressions indeed further enable to construe relevancy rules that are easy to define and understand. The use of if-then rules further enhances the user-friendliness for the administrator that has to define the rules and the healthcare professional that has to use the rules to set his preferences. The if-part or condition of such rules may rely on enhanced contextual information to verify for instance that the comparison study has been reported on, that the comparison study has been linked to certain diagnostic codes, that the comparison study has been linked to the same clinical episode as the active study, that the report that forms part of the comparison study contains certain words, etc. When any or a combination of these conditions is fulfilled the relevancy rule engine shall select the relevancy rule as an applicable rule and execute its then-part. Also the then-part of the rule may rely on enhanced contextual information to select from the comparison medical report for instance a key image, an image that belongs to a baseline study, an image that belongs to the same clinical episode as the active study, etc.

As defined below, the relevancy rule engine in the system to pre-fetch comparison medical studies according to the present invention may further be adapted to pre-fetch and store the subset of comparison medical studies server-side.

Indeed, relevant comparison studies may be determined at two different moments in the workflow: before imaging for a scheduled actual study, or after imaging for an actual study that is being analysed. Before imaging, relevant comparison studies may be pre-fetched in anticipation of for instance a reading task. In this case, server-side pre-fetching of the relevant comparison studies is done, typically a day ahead, and the subset of relevant comparison medical studies is stored server-side because it is not yet known at the moment of pre-fetching the comparison medical studies which healthcare professional will perform the task. The relevancy rule engine may be running on a data processor in a central server, and server-side cache may be used to temporarily store the subset of relevant comparison studies for the scheduled actual study.

Alternatively, the relevancy rule engine in the system to pre-fetch comparison medical studies according to the present invention, may be adapted to pre-fetch and store the subset of comparison medical studies client-side.

Indeed, when the healthcare professional is analysing or starting to analyse the newly acquired actual study, the relevancy rule engine may run on a data processor in or near a client device and pre-fetch relevant comparison medical studies for immediate storage in cache memory in or near the client. This way, the comparison relevant medical studies are faster accessible by the healthcare professional since they no longer have to be transferred over the network.

According to a further optional aspect defined below, the system for pre-fetching comparison medical studies according to the present invention may further comprise:

a client desktop comprising a side-bar listing the subset of comparison medical studies.

Thus, advantageously, the selected relevant comparison medical studies are made accessible to the healthcare professional through a side-bar in the graphical user interface diagnostic desktop. The relevancy rule engine determines which comparison medical studies should be loaded in the clinical side-bar on the client's desktop. This way, presentation of the information on availability of relevant comparison medical studies to the user is improved.

According to yet another optional aspect of the system for pre-fetching comparison medical studies according to the present invention, the client desktop is further adapted to automatically open the comparison medical studies that form part of the subset.

Automatically opening and displaying one or more of the relevant comparison medical studies shall further enhance the user-experience for the healthcare professional that must analyse the actual study.

Still optionally, a system for pre-fetching comparison medical studies according to the present invention may further comprise:

a log memory adapted to memorize for a selected comparison medical study which relevancy rules have determined its relevancy.

The log memory brings the additional advantage that it will be possible at any time to determine for which reason(s) a comparison medical study has been considered relevant in view of the actual study. This knowledge may be helpful in understanding and improving the system.

In addition to a system able to pre-fetch a subset of comparison medical studies, the present invention relates to a corresponding computer-implemented method to pre-fetch in a medical imaging and archiving platform a subset of comparison medical studies in relation to an active medical study, the method being defined below, comprising:

selecting for the active medical study applicable relevancy rules from a relevancy rule database wherein relevancy rules that express relevancy of a comparison medical study in view of an active medical study are stored; and
applying selected relevancy rules to thereby pre-fetch the subset of comparison medical studies from a medical study database that stores medical studies,
wherein the relevancy rules comprise one or more relevancy rule using contextual information stored in a medical report, an order or procedure information that forms part of the medical studies.

The present invention also concerns a data processing system as defined below, comprising means for carrying out the method according to the invention.

Furthermore, the present invention relates to a computer program as defined below, comprising software code adapted to perform the method according to the invention, and a computer readable storage medium as defined below, comprising the computer program.

### BRIEF DESCRIPTION OF THE DRAWINGS

FIG. 1 illustrates the architecture of a preferred embodiment of the system for pre-fetching comparison medical studies according to the present invention.

FIG. 2 illustrates the configuration of enhanced relevancy rules as used in a preferred embodiment of the system and method for pre-fetching comparison medical studies according to the present invention.

### DETAILED DESCRIPTION OF THE PREFERRED EMBODIMENTS

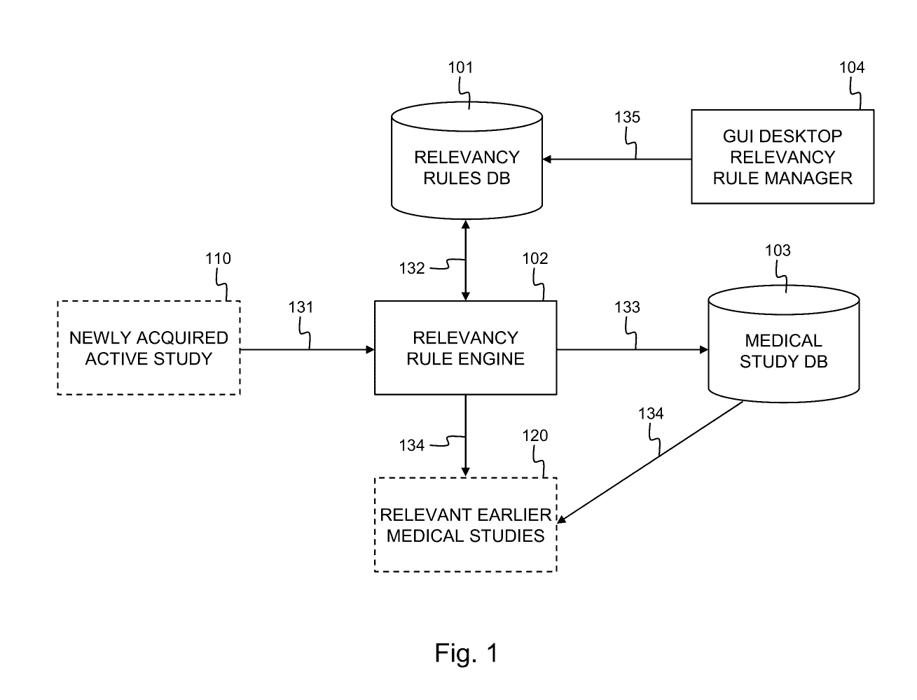

FIG. 1 shows a medical imaging system comprising a relevancy rule database, 101 or RELEVANCY RULES DB, a relevancy rule engine, 102 or RELEVANCY RULE ENGINE, a medical study database, 103 or MEDICAL STUDY DB, and a relevancy rule manager, 104 or GUI DESKTOP RELEVANCY RULE MANAGER. In this system, medical studies are stored in the medical study database 103. These medical studies comprise images but also medical reports, orders, procedural information, etc. Relevancy rules that express criteria for selecting relevant comparison medical studies 120 in relation to a newly acquired actual study 110 are stored in the relevancy rule database 101. These relevancy rules are defined via the relevancy rule manager 104, i.e. a GUI desktop that enables administrators to express the conditions that will be verified to select comparison medical studies in relation to an actual study and to express which information will be extracted from the selected relevant comparison studies for presentation to the user. The relevancy rule engine 103 at last is the unit of the system that will apply the relevancy rules.

For any newly acquired active study 110, relevant comparison medical studies 120 can be determined using relevancy rules stored in the relevancy rule database 101. In a first step, the relevancy rule engine 102 is made knowledgeable on the newly acquired active study 110, as is indicated by arrow 131 in FIG. 1. The relevancy rule engine 102 thereupon applies all rules in the relevancy rule database 101. More precisely, the relevancy rule engine 102 verifies for each relevancy rule in the relevance rule database 101 if the if-part is fulfilled, as indicated by arrow 132 in FIG. 1. This way, the relevancy rule engine 102 selects applicable relevancy rules. For all applicable relevancy rules, the relevancy rule engine 102 then executes the then-part of rule in order to extract certain information from the medical study database 103. This is indicated by arrow 133 in FIG. 1. The relevant comparison medical studies 120 or portions of information defined by the then-part of the relevancy rules are finally pre-fetched as is indicated by arrow 134. The relevant comparison studies 120 may be pre-fetched directly from the medical study database 103 for storage in cache memory, or they may be pre-fetched by the relevancy rule engine 102 for distribution to and storage in cache memory.

According to a preferred embodiment of the invention, enhanced relevancy rules are used wherein a wide variety of parameters can be taken into account in the if-part and/or the then-part of the relevancy rules. The if-part of a relevancy rule may for instance verify if the report severity of a comparison study is high. The if-part of a relevancy study may verify if the comparison study is a baseline study. The if-part of a relevancy rule may verify if the report that forms part of a comparison medical study contains specific words. The if-part of a relevancy rule may verify how old the study is or whether the comparison study belongs to the same clinical episode as the newly acquired active study. The if-part of the relevancy rule may verify if a comparison study is linked to the same diagnostic code(s) as the newly acquired active study. In all these examples, the relevancy rule requires consultation of contextual information of the comparison medical studies that goes beyond pure imaging information.

It is noticed that the system allows to define a relevancy rule for a specific department or a specific user.

The relevant comparison medical studies can be determined by the relevancy rule engine 102 at two different moments. For a scheduled new study, the relevancy rules can be applied before imaging to pre-fetch the relevant comparison studies. Pre-fetching comparison medical studies ahead of the actual study can for instance be done one day ahead of the scheduled new study. Because it is not yet known at the moment of pre-fetching which user will perform the imaging or analyzing task, the pre-fetching is done server-side. Configuration levels will not be taken into account for such server side pre-fetching. Alternatively, or complementary to server-side pre-fetching of comparison medical studies, the relevancy rule engine 102 can also determine which comparison medical studies should be loaded onto the client and displayed in the side bar of the client's diagnostic desktop at the moment an actual study is analyzed.

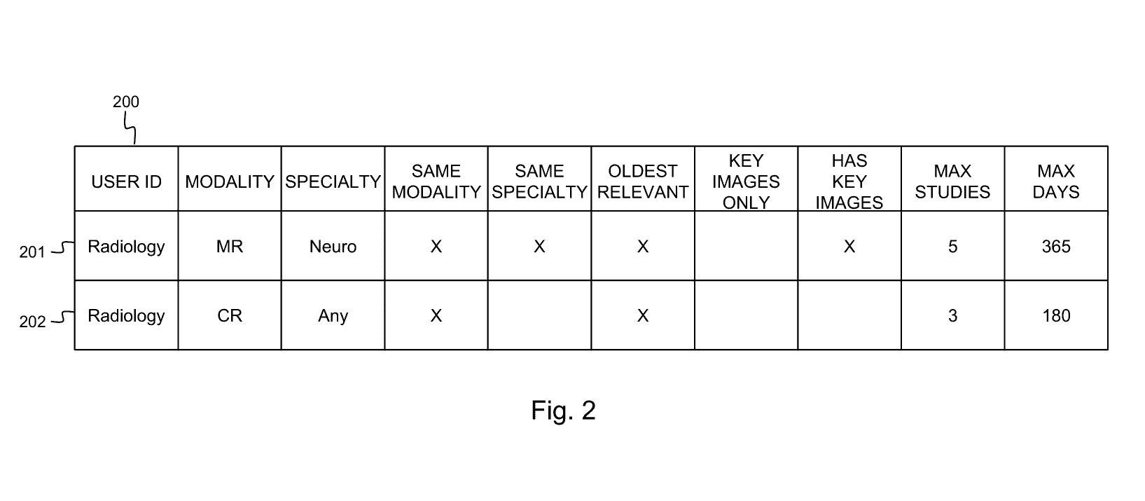

The enhanced relevancy rules use contextual parameters available in the medical report, order or procedure documentation that forms part of the medical study. It has to be understood that said contextual information is not referred to as the information which is stored together with the image data alone (information available in the DICOM tags of medical images) as is the case in the prior art. The said contextual data referenced is data which is stored in medical reports, orders or procedure documentation and which is typically not stored together with the image data, but rather in databases of dedicated systems (such as a RIS-database, clinical information systems, or alike). Therefore, said medical reports, orders or procedure information should be accessible by the relevancy rule engine which will analyse the content of said medical reports, orders or procedure information associated with a certain reference study, in order to retrieve the contextual information from the related reports and—if deemed relevant—reference then said reference study as a relevant prior study. Table 200 in FIG. 2 lists examples of such contextual parameters:

a parameter “modality” or “modality type” may restrict the modality of comparison medical studies that will be considered relevant, e.g. the rule may apply to CR studies only or alternatively may apply to any modality;
a parameter “specialty” may restrict the specialty of comparison medical studies that will be considered relevant, e.g. the rule may apply to Neuro studies only or alternatively may apply to any specialty;
a parameter “same modality” that may be set through a checkbox in the administrator desktop for instance, may result in a relevancy rule that shall select only comparison medical studies that have the same modality type as the actual medical study;
a parameter “same specialty” that may be set through a checkbox in the administrator desktop for instance, may result in a relevancy rule that shall select only comparison medical studies that have the same specialty as the actual medical study;
a parameter “oldest relevant” may result—when set—in a relevancy rule that selects only the oldest comparison medical study that matches the other relevant rule criteria;
a parameter “key images only” may result—when set—in a relevancy rule that selects only key images of comparison medical studies that match the other relevant rule criteria;
a parameter “has key images” that again may be set through a checkbox in the administrator desktop, may result in a relevancy rule that shall select only comparison medical studies that include key images;
a parameter “maximum studies” may limit the number of relevant comparison medical studies that are pre-fetched; and
a parameter “maximum days” may limit how old a comparison study can be to be considered as relevant.

The list of contextual information or parameters that can be used by enhanced relevancy rules obviously is not restricted to the above given examples. As a further example, the appearance of a specific keyword in a medical report could be used as supplementary indicator for a reference study to be relevant as a prior study.

A first rule 201, illustrated by FIG. 2, is configured for the radiologist user. It defines that for new MR studies in the Neuro specialty, any comparison studies from the same modality, i.e. MR, in the same specialty, i.e. Neuro, are considered relevant. The oldest comparison study that matches these criteria is selected. As well, studies that do not have key images are excluded, even if these studies match all other criteria. The maximum number of relevant comparison studies that should be retrieved through this rule is 5, and medical studies that are pre-fetched through this rule shall at most be 365 days old.

A second rule 202, illustrated by FIG. 2, is also configured for the radiologist user and retrieves relevant comparison studies for CR studies from any specialty. Only comparison CR studies shall be considered relevant, and the oldest comparison study that meets these criteria is retrieved. The maximum number of relevant comparison studies pre-fetched through this rule is 3 and pre-fetched comparison studies shall at most be 180 days old.

For healthcare professionals, the system brings the advantage they can work more quickly. When they start to interpret a newly acquired medical study, the possible relevant comparison studies are already available instead of residing in offline media.

For an administrator, the enhanced relevancy rules improve the management of cache space on the computers. Since the most relevant comparison medical studies are made quickly available to the user without overloading the system with comparison medical studies that are likely not useful for diagnosis, the system performs better than a system based on relevancy rules that consider only imaging information. The administrator must balance the need to reduce network traffic and cache space with the requirements of users/physicians that require all relevant comparison medical studies to be identified and quickly accessible. Some healthcare professionals require very specific relevancy rules. For example, when radiologists are focusing on studies from oncology patients, comparison studies from far different modalities and body parts are often considered relevant. This may create a situation in which many comparison studies are considered relevant, hence increasing network traffic and amount of cache space required for pre-fetching.

As soon as all relevant comparison medical studies have been pre-fetched using the enhanced rules defined via the relevancy rule manager 104, the healthcare professional can further accelerate access to relevant comparison medical studies by automatically opening relevant comparison medical studies or portions of information thereof when the actual study is opened.

It is further noticed that the relevancy rules defined via the relevancy rule manager 104 in the GUI administration desktop, affect which comparison medical studies are loaded, for instance in the client's series toolbar and how fast.

When relevancy rules are defined via the administrator desktop, the relevant comparison medical studies are loaded for instance in the client's series toolbar in the image area. Hanging protocols then determine what is displayed in the viewports. The comparison studies loaded in the client's series toolbar may optionally open automatically in the viewports with the actual medical study, e.g. when this is specified in the hanging protocols, but this is not necessary. The loaded comparison studies anyhow shall open fast. When other comparison medical studies must be opened, they must be selected from a list. Such comparison medical studies however shall not open as quickly because they were not pre-fetched based on the relevancy rules defined via the administrator desktop.

It is noticed that a method according to the present invention or certain steps thereof shall typically be computer-implemented to run on a data processing system or computing device. A data processing system or computing device that is operated according to the present invention can include a workstation, a server, a laptop, a desktop, a hand-held device, a mobile device, a tablet computer, or other computing device, as would be understood by those of skill in the art.

The data processing system or computing device can include a bus or network for connectivity between several components, directly or indirectly, a memory or database, one or more processors, input/output ports, a power supply, etc. One of skill in the art will appreciate that the bus or network can include one or more busses, such as an address bus, a data bus, or any combination thereof, or can include one or more network links. One of skill in the art additionally will appreciate that, depending on the intended applications and uses of a particular preferred embodiment, multiple of these components can be implemented by a single device. Similarly, in some instances, a single component can be implemented by multiple devices.

The data processing system or computing device can include or interact with a variety of computer-readable media. For example, computer-readable media can include Random Access Memory (RAM), Read Only Memory (ROM), Electronically Erasable Programmable Read Only Memory (EEPROM), flash memory or other memory technologies, CDROM, digital versatile disks (DVD) or other optical or holographic media, magnetic cassettes, magnetic tape, magnetic disk storage or other magnetic storage devices that can be used to encode information and can be accessed by the data processing system or computing device.

The memory can include computer-storage media in the form of volatile and/or nonvolatile memory. The memory may be removable, non-removable, or any combination thereof. Exemplary hardware devices are devices such as hard drives, solid-state memory, optical-disc drives, or the like. The data processing system or computing device can include one or more processors that read data from components such as the memory, the various I/O components, etc.

The I/O ports can allow the data processing system or computing device to be logically coupled to other devices, such as I/O components. Some of the I/O components can be built into the computing device. Examples of such I/O components include a microphone, joystick, recording device, game pad, satellite dish, scanner, printer, wireless device, networking device, or the like.

Although the present invention has been illustrated by reference to specific preferred embodiments, it will be apparent to those skilled in the art that the invention is not limited to the details of the foregoing illustrative preferred embodiments, and that the present invention may be embodied with various changes and modifications without departing from the scope thereof. The present preferred embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and preferred embodiments of the invention are capable of operating according to the present invention in other sequences, or in orientations different from the one(s) described or illustrated above.

1-13. (canceled)

14. A system for pre-fetching in a medical imaging and archiving platform a subset of comparison medical studies in relation to an active medical study, the system comprising:
a relevancy rule engine that selects for the active medical study applicable relevancy rules from a relevancy rule database, and that applies selected relevancy rules to pre-fetch the subset of comparison medical studies; wherein
the relevancy rules include one or more relevancy rules extracted from contextual information stored in a medical report, an order, or a procedure information included in the subset of comparison medical studies.

15. The system according to claim 14, wherein the contextual information includes Radiology Information System data.

16. The system according to claim 14, further comprising a relevancy rule manager that defines the relevancy rules in a translatable domain specific language.

17. The system according to claim 16, wherein
the relevancy rule manager defines the relevancy rules as if-then rules; and
the relevancy rule engine verifies fulfilment of the if-then rule of the selected relevancy rules in order to select the applicable relevancy rules, and to execute the “then” part of the if-then rule of the selected relevancy rules to pre-fetch the subset of comparison medical studies.

18. The system according to claim 14, wherein the relevancy rule engine pre-fetches and stores the subset of comparison medical studies on a server of a data processor that includes the relevancy rule engine.

19. The system according to claim 14, wherein the relevancy rule engine pre-fetches and stores the subset of comparison medical studies on a client-side desktop.

20. The system according to claim 14, further comprising:
a client desktop that lists the subset of comparison medical studies.

21. The system according to claim 20, wherein the client desktop automatically opens comparison medical studies that form a part of the subset of comparison medical studies.

22. The system according to claim 14, further comprising:
a log memory that stores, for a selected comparison medical study, the relevancy rules that determine that the selected comparison medical study is relevant.

23. A computer-implemented method for pre-fetching in a medical imaging and archiving platform a subset of comparison medical studies in relation to an active medical study, the method comprising the steps of:
selecting for the active medical study relevancy rules from a relevancy rule database that express relevancy of a comparison medical study in view of the active medical study; and
applying selected relevancy rules to pre-fetch the subset of comparison medical studies from a medical study database that stores medical studies; wherein
the relevancy rules include one or more relevancy rules extracted from contextual information stored in a medical report, an order, or procedure information included in the subset of comparison medical studies.

24. A non-transitory computer readable storage medium comprising software code adapted to carry out the steps of claim 14 when run on a computer.
